(19) United States
(12) Patent Application Publication
(10) Pub. No.: US 2017/0083972 A1
(43) Pub. Date: Mar. 23, 2017

(54) Automated Financing Workflow

(71) Applicant: CIT Bank, N.A., Livingston, NJ (US)

(72) Inventors: James Broom, Rye, NH (US); Stephen Lankler, Stratham, NH (US)

(21) Appl. No.: 15/370,792

(22) Filed: Dec. 6, 2016

Related U.S. Application Data
(63) Continuation of application No. 14/329,315, filed on Jul. 11, 2014, now abandoned.
(60) Provisional application No. 61/859,383, filed on Jul. 29, 2013.

(51) Int. Cl. G06Q 40/02; G06Q 10/10; G06F 9/44; H04L 29/08

(52) U.S. Cl. CPC G06Q 40/02; H04L 67/02; G06Q 10/103; G06F 9/4443

(57) ABSTRACT

A computer-based system processes applications for financing, such as applications for equipment financing. The system represents each financing application process using a collection of data structures, referred to as “navigable items.” Each person involved in a financing application process, such as the applicant, sales representative, and sales manager, may be assigned a corresponding role. The user experience that the system provides to each user in connection with the financing application process, such as the information that the system does and does not present to the user in connection with the financing application process, varies depending on the content of the navigable items within the process and the role of the user in the process. In this way, embodiments of the present invention provide a flexible system that adapts its behavior both to different financing products and to the roles of different users within financing application processes.

### BACKGROUND

The process of applying for lease, loan and working capital financing for business needs such as equipment, technology, real estate, and capital improvements is tedious, time-consuming, and error-prone. Even in today's electronic age, financing applications often are initiated by the applicant completing a standard paper form and then transmitting that form to the financing company, either in person, by mail, by fax, or by email. Data from the application must then be re-entered manually into a computer, thereby creating opportunities for error and other inefficiencies. Even when systems are used which enable the applicant to input the application information directly into a software application, such as by filling out fields in an online questionnaire, the resulting application process typically mirrors that of the traditional paper-based process. For example, such systems typically use rigid “one size fits all” online forms which are incapable of adapting to the needs of particular applicants, differences in financing types, and other characteristics that may vary from application to application. Such inflexibility makes the process inefficient for both the applicant and the financing company.

What is needed, therefore, are improved techniques for processing financing applications.

### SUMMARY

A computer-based system processes applications for financing, such as applications for equipment financing. The system represents each financing application process using a collection of data structures, referred to as “navigable items.” Each person involved in a financing application process, such as the applicant, sales representative, and sales manager, may be assigned a corresponding role. The user experience that the system provides to each user in connection with the financing application process, such as the information that the system does and does not present to the user in connection with the financing application process, varies depending on the content of the navigable items within the process and the role of the user in the process. In this way, embodiments of the present invention provide a flexible system that adapts its behavior both to different financing products and to the roles of different users within financing application processes.

For example, one embodiment of the present invention is directed to a computer-implemented method including: (A) receiving a request from a user to access a portal for processing a financing application; (B) identifying a role associated with the user; (C) identifying an organization and tier associated with the portal; and (D) granting, to the user, permission to access the tier of the portal as dictated by the role associated with the user.

Other features and advantages of various aspects and embodiments of the present invention will become apparent from the following description and from the claims.

### BRIEF DESCRIPTION OF THE DRAWINGS

FIG. 1 is dataflow diagram of a system for controlling the user experience in a system for processing financing applications;

FIG. 2 is a flowchart of a method performed by the system of FIG. 1;

FIG. 3 is a diagram of a data structure for storing data representing a financing product; and

FIGS. 4A-4C are illustrations of user interfaces for displaying navigable items according to one embodiment of the present invention.

### DETAILED DESCRIPTION

Business financing involves a complex set of interactions between multiple parties that can vary from situation to situation. Embodiments of the present invention are directed to a computer system which enables business financing applications to be created, submitted, and processed easily in a wide variety of situations. By incorporating the ability to process financing applications having a wide variety of characteristics and for use by a wide variety of organizations, embodiments of the present invention enable such applications to be processed electronically with a minimum of effort.

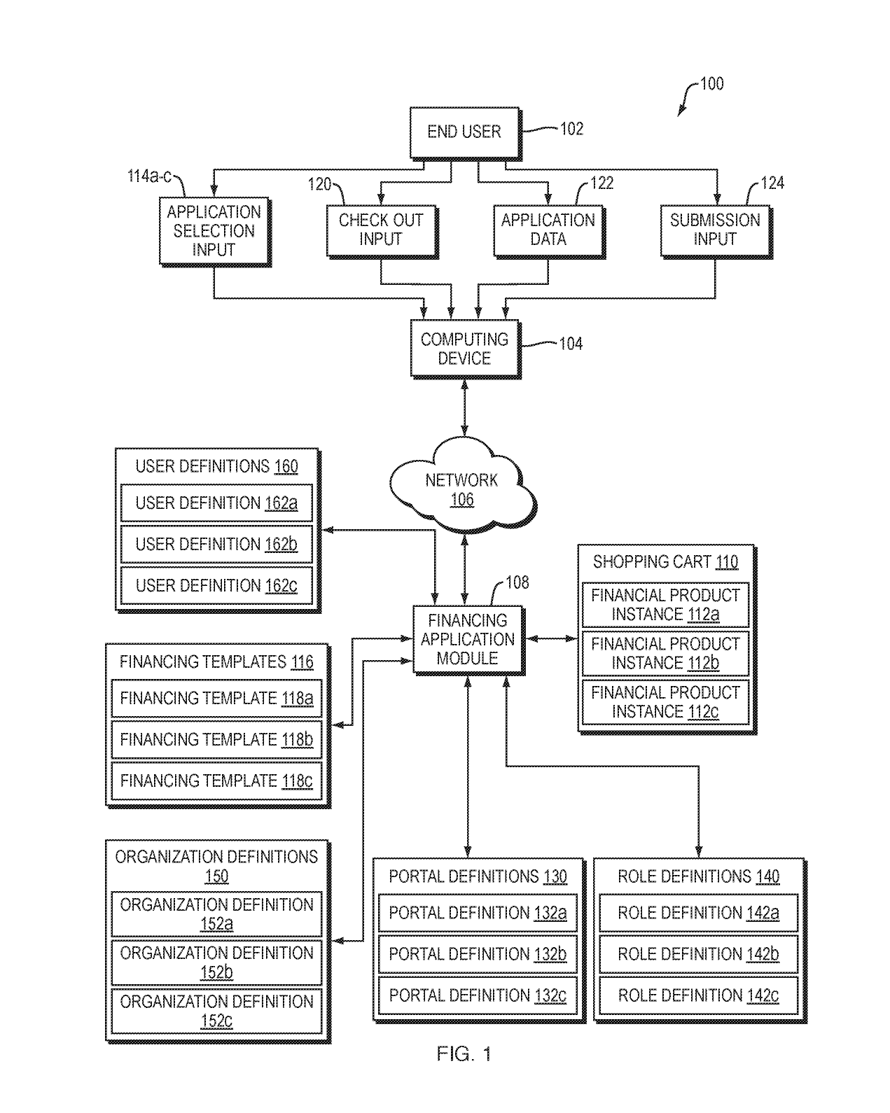

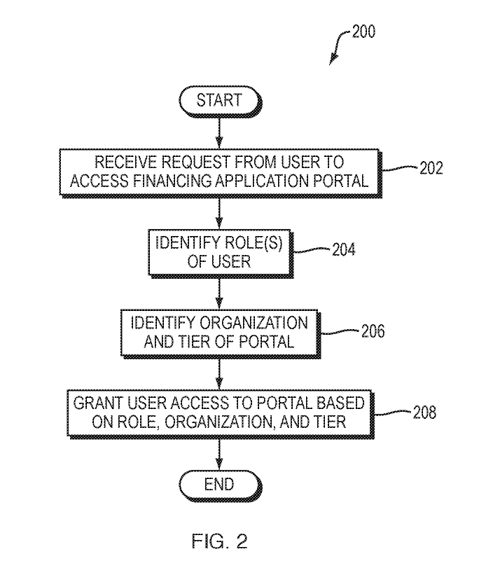

For example, referring to FIG. 1, a dataflow diagram is shown of a system 100 for processing financing applications according to one embodiment of the present invention. Referring to FIG. 2, a flowchart is shown of a method 200 that is performed by the system 100 of FIG. 1 according to one embodiment of the present invention.

In summary and overview, an end user 102 of the system 100 provides a request to the system 100 to access a financing application portal (FIG. 2, operation 202). The system 100 identifies one or more roles of the user 102 (FIG. 2, operation 204). The system 100 also identifies an organization (e.g., company) and tier associated with the portal to which the user 102 requests access (FIG. 2, operation 206). For example, the request from the user 102 to access the application portal may specify the organization and/or tier to which the user 102 requests access, in which case the system 100 may identify the requested organization and/or tier based on information contained in the user 102's request. The system 100 then grants access to the user 102, and otherwise tailors the user's experience of the financing application process, based on the user's role(s) and the organization and tier of the portal (FIG. 2, operation 208).

More specifically, in the system 100 of FIG. 1, the end user 102 uses a computing device 104 to communicate with a financing application module 108 over a network 106. The end user 102 may, for example, be an applicant for a business financing product, such as the owner of a business, or a representative or agent of the applicant, such as a sales agent or sales manager. Although the end user 102 and other users may be referred to herein as “applicants,” the end user 102 need not be an applicant for financing, but instead may be any user of the system 100 who performs the functions disclosed herein. Although the end user 102 may be a human user, this is not a limitation of embodiments of the present invention. Alternatively, for example, the end user 102 may be a computer program, computing device, other system, or any combination thereof.

The computing device 104 may be any computing device, such as a desktop computer, laptop computer, tablet computer, smartphone, or a combination thereof. The financing application module 108 may include computer hardware, software, or a combination thereof. For example, the financing application module 108 may be a computer which executes server software for executing the functions disclosed herein, in which case the computing device 104 may execute client software (such as a web browser or custom-designed client software) for communicating with the server software on the financing application module 108. These are merely examples, however, and do not constitute limitations of the present invention.

The network 106 may be any kind of network, such as the public Internet, a private intranet, or a combination thereof. The network 106, however, is not a requirement of the present invention. For example, the functions performed by the computing device 104 and the financing application module 108 may be combined into and performed by a single computer, such as a single computer executing software which performs the functions disclosed herein as being performed by the computing device 104 and the financing application module 108. In such a case, some or all of the functions disclosed herein may be performed without the use of the network 106.

The system 100 may enable the end user 102 to add one or more financing products to a virtual shopping cart 110 associated with the end user 102. The shopping cart 110 may be represented by and stored in a data structure stored in a non-transitory computer-readable medium. Although only one end user 102 and one shopping cart 110 are shown in FIG. 1 for ease of illustration, the system 100 may support any number of shopping carts for any number of users. Therefore, any techniques disclosed herein in connection with the end user 102 and the shopping cart 110 should be understood to be equally applicable to any number of users and any number of shopping carts. Furthermore, the term “shopping cart” is used merely as an illustrative example. More generally, the shopping cart 110 should be understood to refer to any data structure representing one or more financing products for which the end user 102 wishes to apply.

For example, the financing application module 108 may provide the end user 102, via the computing device 104, with a graphical user interface which presents the end user 102 with a virtual storefront in which the end user 102 may view information about a variety of financing products for which the end user 102 may apply. Depending on which portal the end user 102 has logged into, the virtual storefront might behave differently and/or display different products and/or terms. To add one of the available financing products to the end user 102's shopping cart 110, the end user 102 provides financing product selection input 114a to the computing device 104. The input 114a indicates a particular financing product for which the end user 102 wishes to apply. The end user 102 may provide the input 114a by, for example, clicking on a graphical representation of a particular financing product and clicking on an “Add to Cart” button.

The computing device 104 may provide the input 114a, or data derived therefrom, to the financing application module 108 over the network 106. In response, the financing application module 108 may add, to the end user 102's shopping cart 110, data representing the financing product specified by the input 114a. In the example of FIG. 1, assume that input 114a results in the addition of financing product instance 112a to the end user 102's shopping cart 110.

The end user 102 may continue to view additional financing products and continue to add additional financing products to the end user 102's shopping cart 110. Assume for purposes of example that, as shown in FIG. 1, the end user 102 provides input 114b, which causes the financing application module 108 to add financing product instance 112b to the end user 102's shopping cart 110, and that the end user 102 provides input 114b, which causes the financing application module 108 to add financing product instance 112b to the end user 102's shopping cart 110. Although three financing product instances 112a-c are shown in FIG. 1 for purposes of example, the shopping cart 110 may include any number of financing product instances.

The system 100 may require the end user 102 to specify, for each selected financial product, the location at which that financial product applies, and the owner (person or organization) of the specified location. For example, if the end user 102 is an owner of a franchise of a franchisor that has multiple franchisees, when the end user 102 provides input 114a to select a first financial product instance (e.g., financial product instance 112a), the end user 102 may provide input indicating the franchise owned by the end user 102 as the location at which the financial product applies, and provide input indicating that the end user 102 is the owner of that franchise.

The end user 102 may provide such information as part of the input 114a-c for each of the financial product instances 112a-c in the end user 102's shopping cart 110. The financing application module 108 may store the location and owner information of each selected financial product within the corresponding one of the financial product instances 112a-c. In this way, the system 100 enables the end user 102 to apply for financing for multiple locations (e.g., multiple businesses or multiple locations of the same business) in one financing application.

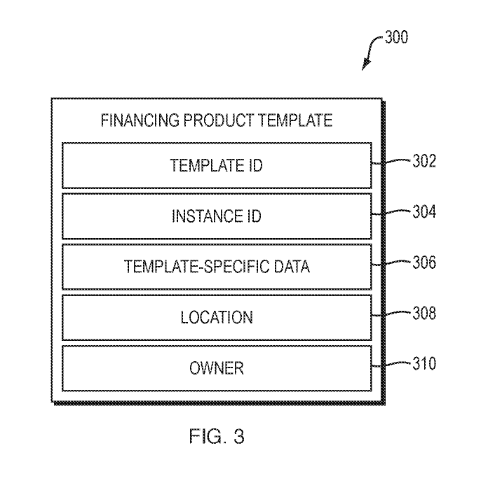

More specifically, referring to FIG. 3, a diagram is shown of a template 300 for storing information about a navigable item. The template 300 includes:
a template identifier (ID) section 302, for storing a unique identifier of the template 300, such as a human-readable name (e.g., “long-term equipment lease”) and/or a computer-readable identifier;
an instance identifier (ID) section 304, for storing a unique identifier of an instance of the template 300;
a template-specific data section 306, for storing data that is specific to the template 300;
a location section 308, for storing information about the location of a financing product applicant; and
a location owner section 310, for storing information about the owner of the location specified in location section 308.

The particular format of the template 300 shown in FIG. 3 is merely an example and does not constitute a limitation of the present invention.

Referring again to FIG. 1, the system 100 may include a store of navigable item templates, such as financing product templates 116. Although FIG. 1 specifically shows templates of financing products, more generally the templates 116 may be templates of navigable items. The templates 116 include templates 118a-c, each of which may have the structure of the template 300 shown in FIG. 3. The data stored in the sections 302, 304, 306, 308, and 310 of each of the templates 118a-c may differ from each other. For example, the first template 118a may have a different template ID 302 and different template-specific data fields 306 than the second template 118b. Although three templates 118a-c are shown in FIG. 1 for ease of illustration, the system 100 may include any number of templates.

When the end user 102 selects a particular financing product to add to the end user 102's shopping cart 110, the financing application module 108 may identify a template, within the template store 116, which corresponds to the financing product selected by the end user 102. The financing application module 108 may then create a financing product instance 112a based on (e.g., having the same structure as) the identified template. Any input provided by the end user 102 in connection with a particular financing product, such as the intended location of use of the financing product and the owner of that location, may be stored by the financing application module 108 in the corresponding sections of the financing product instance (e.g., sections 308 and 310, respectively, in the case of location and owner).

After the end user 102 has finished adding financial products to the end user 102's shopping cart 110, the end user 102 provides input 120 to the computing device 104 indicating that the end user 102 is ready to check out (i.e., to provide all information necessary to submit a complete application for all of the financing products in the end user 102's shopping cart 110). The computing device 104 may provide the input 120 to the financing application module 108 over the network 108.

The financing application module 108 may then, for each of the financing products 112a-c in the end user 102's shopping cart 110, solicit and obtain from the end user 102 detailed input 122 representing:
information to store in the template-specific data section 306 of the financing product (e.g., data that is specific to the type of financing product, which may differ from financing product to financing product);
information to store in the location section 308 of the financing product, such as the legal structure of the business, the mailing address of the location associated with the financing product, and any other contact information associated with that location; and
information to store in the owner section 310 of the financing product, such as the full name, mailing address, telephone number, and email address of the location owner.

The financing application module 108 may store the data received from the end user 102 via input 122 within the associated financial product instances 112a-c in the end user 102's shopping cart. The financing application module 108 may permit or require the end user 102 to provide additional information, such as documentation in support of the end user 102's financing application. The financing application module 108 may store such additional information in the shopping cart 110.

The system 100 may provide the end user 102 with the ability to review all submitted information and then to provide input 124 indicating that the submission is complete (such as by clicking a “Submit” button). In response to receiving the submission input 124, the financing application module 108 considers the information contained within the shopping cart 110 to represent the end user 102's financing application. The financing application module 108 may then provide the application data in the shopping cart 110 to a loan officer or other person to begin processing of the application.

As the description above illustrates, embodiments of the present invention may be used to simplify, systematize, and streamline the process of applying for one or more financing products. One benefit of the system 100 is that it enables the end user 102 to apply for multiple financing products easily through one application process. Another benefit of the system 100 is that it prompts the end user 102 to provide all information required to submit a complete application, thereby reducing or eliminating the possibility that the end user 102 will omit information from the application which would require the loan officer to request that information from the end user 102 separately. Another benefit of the system 100 is that it supports multiple types of financing product application which may require different data than each other. The system 100 is flexible in this way and also extensible to include new types of financing products without requiring re-engineering of the system 100.

As mentioned above, the system 100 may present the end user 102 with a graphical user interface for selecting financing products to add to the end user 102's shopping cart, and for providing any of the data described herein, such as the detailed data 122 required to apply for the financing products in the shopping cart 110. Embodiments of the present invention may modify such a user interface in a variety of ways, based on factors such as the identity of the end user 102 and the types of financing products for which the end user 102 is applying. Such modifications include, for example, selecting which content to displayed to the end user 102, selecting which content to hide from the end user 102, and/or modifying the sequence in which such content is displayed to the end user 102.

For example, the financing application module 108 may be accessible via a web browser at any of a plurality of URLs. Consider, for example, a configuration in which the financing application module 108 is associated with the domain lendedge.com, and in which the financing application module 108 is accessible via the following three URLs: abc.lendedge.com, def.lendedge.com, and ghi.lendedge.com. The financing application module 108 may associate each of the host portions of these URLs (i.e., abc, def, and ghi) with a different user experience in the financing application process 200.

For example, assume that the end user 102 navigates a web browser to one of the URLs listed above to access the financing application module 108 and thereby to initiate the method 200 of FIG. 2 described above. When the financing application module receives the HTTP request from the end user 102's web browser, the financing application module 108 may examine that request to identify the host portion of the URL (in this example, either abc, def, or ghi). The financing application module 108 may then provide the end user 102 with a different user experience within the financing application process depending on which host portion was used to access the financing application module 108. For example, if the financing application module 108 was accessed with a first host portion (e.g., abc), then the financing module may provide the end user 102 with a first user experience (e.g., user interface); whereas if the financing application module 108 was accessed with a second host portion (e.g., def), then the financing module may provide the end user 102 with a second user experience (e.g., user interface).

The use of the host portion of a URL to select a user experience is merely an example and does not constitute a limitation of the present invention. Even more generally, the use of a URL to select a user experience is merely an example and does not constitute a limitation of the present invention. More generally, the financing application module 108 may receive a request from the end user 102 (whether or not an HTTP request) to initiate the process 200 of FIG. 2 and select a user experience based on any property or properties of that request. For example, the financing application module 108 may identify a location of the request (such as based on an IP address of the request) and select the user experience based in whole or in part on that location.

The system 100 may store data representing each available user experience. In the example illustrated in FIG. 1, the system 100 includes a store 130 of portal definitions 132a-c. As will be described in more detail below, the system 100 may use each of the portal definitions 132a-c to provide the end user 102 with a distinct user experience within the application process 200. Each of the portal definitions 132a-c may be associated with a distinct request property or combination of properties. For example, if the financing application module 108 uses the request URL host name to select user experiences, then portal definition 132a may be associated with a first URL host name (e.g., abc in abc.lendedge.com), portal definition 132b may be associated with a second URL host name (e.g., def in def.lendedge.com), and portal definition 132c may be associated with a third URL host name (e.g., ghi in ghi.lendedge.com). In this example, if the end user 102 navigates to URL abc.lendedge.com, then the financing application module 108 may identify portal definition 132a as corresponding to the HTTP request to access abc.lendedge.com, and in response the financing application module 108 may use the data in portal definition 132a to provide the user experience to end user 102 in the application process 200.

Each of the portal definitions 132a-c may contain one or more data structures referred to herein as “navigable items.” Each navigable item may represent, for example, a subset of a portal that the end user 102 may navigate to directly via a web browser. A navigable item may, for example, represent a single web page, a collection of related web pages, or an entire application for a financing product. A navigable item may, for example, be associated with a corresponding URL, such that if the end user 102's web browser navigates to the corresponding URL, this causes the financing application module 108 to provide the navigable item (or data derived therefrom) to the end user 102's web browser, which may then render the navigable item to the end user 102. The data representing each navigable item in the portal definitions 130 may indicate the URL associated with that navigable item. Returning to the example above, if portal definition 132a represents a portal accessible at URL abc.lendedge.com, then each of the navigable items within the portal definition 132a may represent one or more web pages accessible within abc.lendedge.com. For example, a first one of the navigable items within portal definition 132a may represent a web page accessible at abc.lendedge.com/page1.html, while a second one of the navigable items within portal definition 132a may represent a web page accessible at abc.lendedge.com/page2.html. A URL such as abc.lendedge.com/page1.html refers to a navigable item, not to a file named “page1.html,” as it would in the case of a traditional web site.

If the end user 102 uses a web browser executing on the computing device 104 to navigate to a web page associated with a particular navigable item (e.g., the web page abc.lendedge.com/page1.html), the financing application module 108 may, for example, receive the HTTP request to navigate to that web page and:
as described above, use the host portion (i.e., abc) of that URL to identify the portal definition 132a associated with the request;
use the URL key of that URL (i.e., page1.html) to identify the navigable item associated with the request; and
return the identified navigable item to the end user 102's computing device 104 for rendering by the web browser executing on the computing device 104.

The system 100 may support different types of navigable items. As a result, distinct navigable items within the portal definitions 130 may have types that differ from each other. Examples of navigable item types include:
Account: Provides forms for logging in, registering, and resetting passwords.
Application Flow: Renders a store with financing products, product detail pages, and financing forms.
Content Page: Renders as a static content page.
Dashboard: Displays information about previously submitted applications and components linking to other navigable items.
Home Page: Displays the portal's home page.
Profile Management: Displays a page for enabling the end user 102 to manage his account profile.

Before the financing application module 108 responds to the request from the end user 102's web browser to navigate to a particular navigable item, the financing application module 108 may need to perform one or more initialization steps. The steps that are performed may vary depending on the type of the navigable item. For example, the financing application module 108 may perform the following initialization steps for navigable items of the following types (in which references to the “database” refer to the portal definitions 130):
Account: No initialization required.
Application Flow: Retrieve the application from the database; retrieve configuration (including products) from the database; retrieve user profile information to pre-populate form fields; retrieve portal hierarchy information from the database; and generate a client view model to send to the client (e.g., web browser on the computing device 104).
Content Page: Load content from the database and render it on the page.
Dashboard: Retrieve the dashboard configuration for the end user 102; retrieve data necessary to populate the dashboard session; and generate a client view model to send to the client.
Home Page: Retrieve the products for the current portal to display on the home page.
Profile Management: Retrieve profile information for the end user 102 and generate a client view model to send to the client.

Although, as indicated above, navigable items of different types may contain different properties, certain properties may be common to navigable items of all types. For example, all navigable items may include properties such as page title, URL, which HTML, CSS, and JavaScript templates to load for the navigable item, and whether the navigable item requires an authenticated session. Two instances of the same type of navigable item may have properties which indicate different HTML, CSS, and JavaScript templates. As a result, the system 100 may render distinct instances of the same navigable item type differently.

The system 100 may also include a store 140 of role definitions 142a-c. Each of the role definitions 142a-c contains data that defines a corresponding role. Examples of roles include “Sales Manager” and “Corporate User.” Although only three role definitions 142a-c are shown in FIG. 1 for ease of illustration, the system 100 may include any number of role definitions. Furthermore, although a unified set of role definitions 140 is shown in FIG. 1, different portals and/or organizations may be associated with different role definitions. For example, one set of role definitions may be associated with portal definition 132a, while another set of role definitions may be associated with portal definition 132b.

Each of the role definitions 142a-c may contain data specifying the privileges, also referred to herein as “claims” or “permissions,” associated with the corresponding role. Examples of claims are “Can Log In” and “Can Submit Applications.” One role may specify a first set of claims (e.g., “Can Log In”), and another role may specify a second set of claims (e.g., “Can Submit Applications”) which differs from the first set of claims. When a particular role is assigned to a particular user within the system 100, such a role assignment specifies that the particular user is permitted to perform the actions specified by the particular role. In this way, roles may be assigned to users within the system 100 to specify the actions that such users are permitted to perform within the system 100.

The system 100 may also include a store 150 of organization definitions 152a-c. Each of the organization definitions 152a-c contains data that defines a corresponding organization. For example, each of the portal definitions 132a-c may correspond to a distinct organization. Although only three organization definitions 152a-c are shown in FIG. 1 for ease of illustration, the system 100 may include any number of organization definitions. The organization definitions 152a-c may correspond to the same organizations as the portal definitions 132a-c. For example, organization definition 152a may correspond to the same organization as portal definition 132a; organization definition 152b may correspond to the same organization as portal definition 132b; and organization definition 152c may correspond to the same organization as portal definition 132c.

Each of the organization definitions 152a-c may contain data representing an organizational structure of the corresponding organization, such as data representing the hierarchical (e.g., parent-child) relationships among organizational components such as divisions, departments, and subsidiaries within a particular organization. Such data may be represented as a tree structure, which may have as few as a single node or a large number of numbers having a complex hierarchical structure.

The system 100 may also include a store 160 of user definitions 162a-c. Each of the user definitions 162a-c contains data that represents a corresponding user of the system 100. For example, user definition 162a may contain data representing end user 102. Although only three users definitions 162a-c are shown in FIG. 1 for ease of illustration, the system 100 may include any number of user definitions.

Each of the user definitions 162a-c may contain data specifying a role, an organization, and a tier (within the organization) for the corresponding user. The data specifying a role may, for example, point to or otherwise specify one or more of the role definitions 142a-c. A user whose user definition indicates that the user has a particular role is considered by the system 100 to have the claims (privileges) specified by that role, and to be associated with the tier(s) specified by that role. A user may have more than one role. If a user has multiple roles, then the user may have the union of the claims of all of the user's roles. If higher roles include all of the claims of lower roles, then instead of assigning multiple roles to a user, the user may merely be assigned the highest of the multiple roles to effectively assign the user the union of the claims of all of the roles.

The data specifying an organization for a user may, for example, point to or otherwise specify one of the organization definitions 152a-c. The data specifying a tier for a user may, for example, point to or otherwise specify a particular tier (e.g., tree depth) within the organization definition associated with the user. As will be described in more detail below, the organization and tier associated with a user dictates which data within the system (specifically, within the portal definitions 130) the user is permitted to access. For example, if a particular user is associated with organization A and tier B in the portal defined by portal definition 132a, then the system 100 may permit the particular user to access only navigable items in tier B, and in tiers lower than tier B, in the portal defined by portal definition 132a.

Portals may also be associated with tiers. For example, each of the portal definitions 132a-c may specify a corresponding organization and tier within that organization.

When a particular user (such as end user 102) logs into a particular portal, the financing application module 108 may identify: (1) the role(s) specified by the user's user definition; and (2) the organization and tier specified by the user's user definition. The financing application module 108 grants, to the user, permission to access navigable items within the portal as dictated by the user's assigned role, organization, and tier (FIG. 2, operation 208). For example, the financing application module 108 may grant, to the user, permission to access navigable items within the portal that are in the tier specified by the user's user definition, and navigable items within descendants of that tier (i.e., within all tiers that are lower within the hierarchy of the portal than the tier specified by the user's user definition).

The permissions that are granted to the user may dictate, for example, which navigable items the financing application module 108 will display to the user and/or which navigable items the user is allowed to interact with. For example, if a user does not have permission to access a navigable item that is a web page, then the financing application module 108 may not display the web page to the user. As another example, if a user does not have permission to edit a text field, the financing application module 108 may not display the text field to the user, or may display the text field to the user but disable the text field so that the user cannot provide input into it. As another example, if a user does not have permission to submit applications, then the financing application module 108 may disable or omit the “submit” button in an Application Flow navigable item. As yet another example, if a user has the role of “Sales Representative,” then the financing application module 108 may permit the user to submit applications on behalf of other users.

As mentioned above, a portal may include a collection of navigable items. The collection of navigable items within a portal may have a hierarchical set of relationships within the portal. For example, a navigable item within a portal may have sub-items within the portal. The portal definitions 132a-c may contain data representing such hierarchical relationships among navigable items. The type of a particular navigable item N may dictate which types of items may be sub-items of navigable item N. As an example of a navigable item having sub-items, a navigable item of type Application Flow (which represents an entire financing application process) may have images as sub-items. The techniques described herein for granting/denying permission to navigable items and for modifying the user's experience based on such permissions apply equally to all navigable items and to sub-items of those navigable items. As a result, embodiments of the present invention may be used to grant and deny permissions to a portal or to any portion thereof, such as a collection of web pages within the portal, a single web page within a portal, or a portion of a web page within a portal (such as a text field, checkbox, dropdown list, or any other content, data, code, or interface element within the portal).

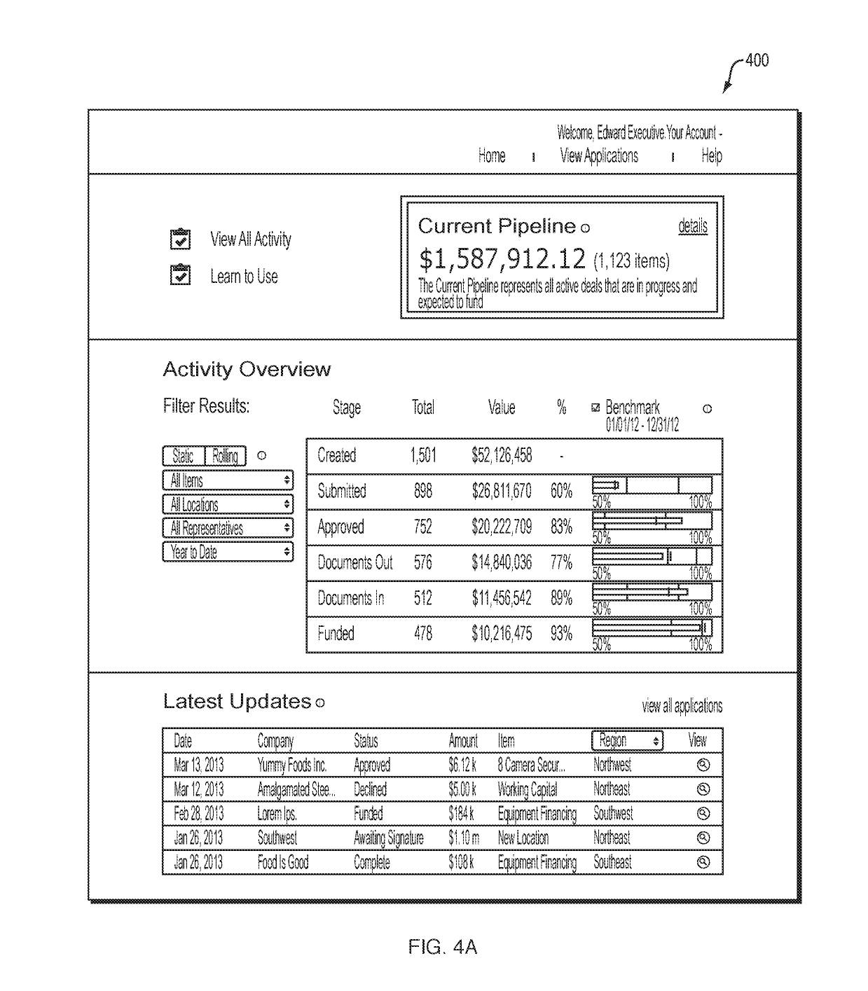

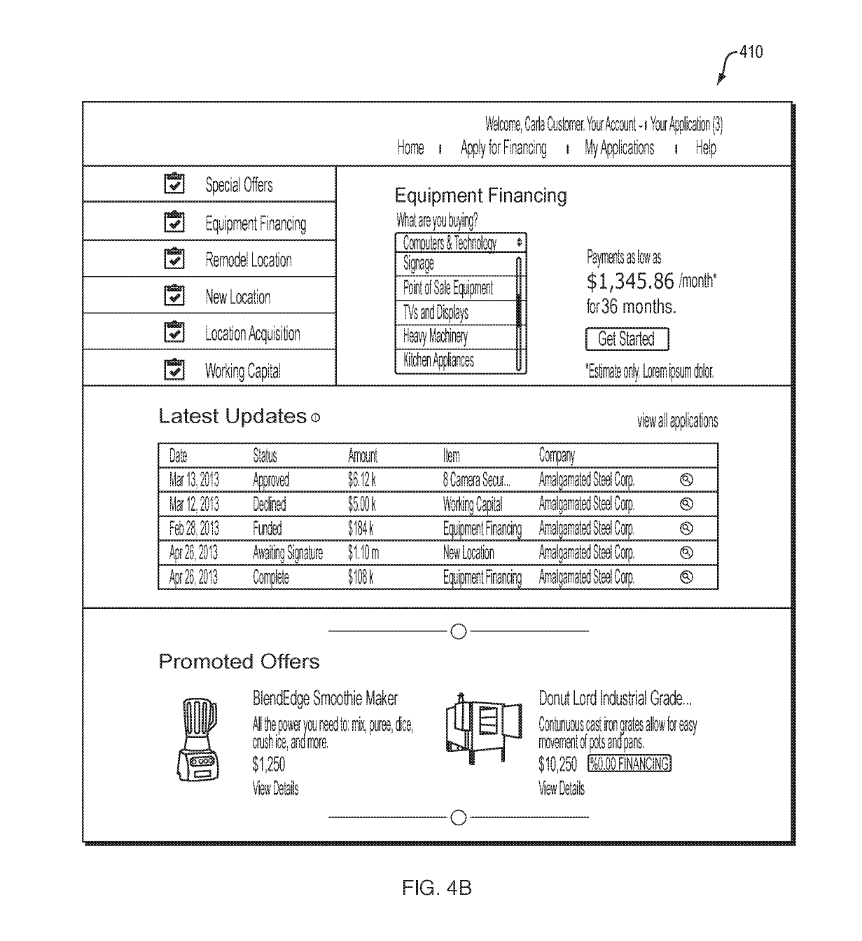

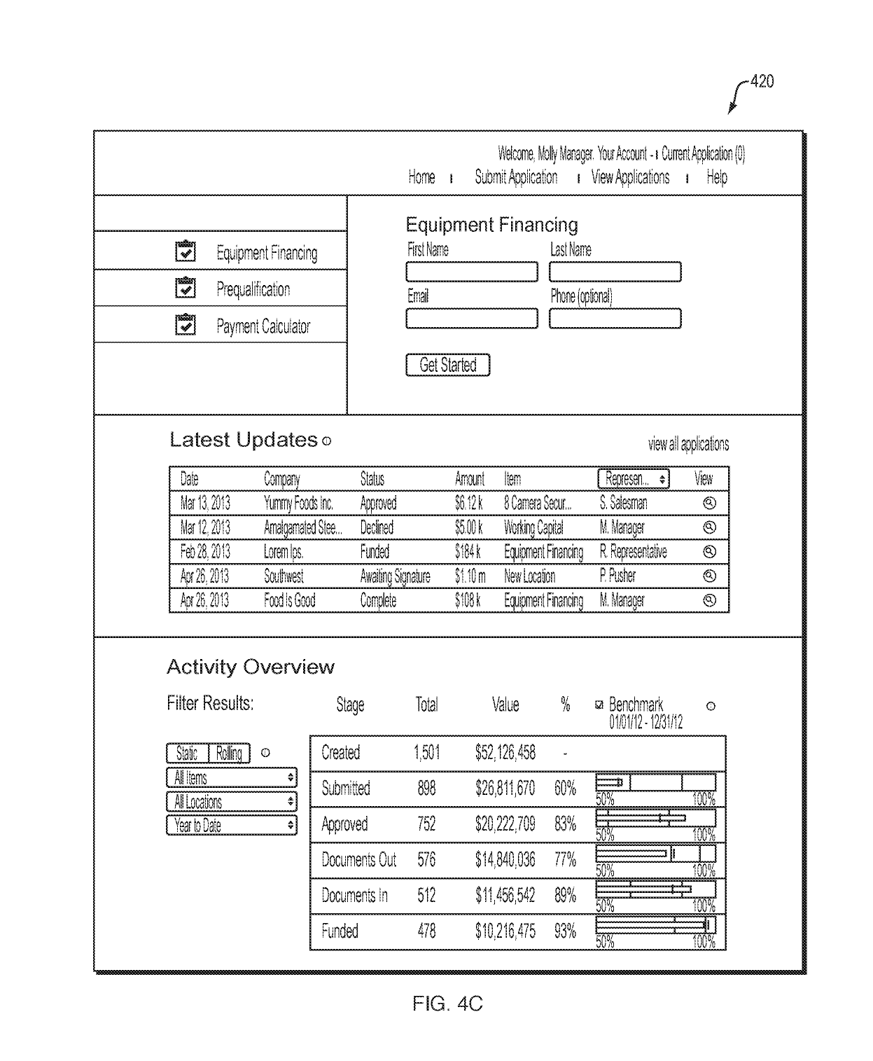

Referring to FIGS. 4A-4C, examples are shown of user interfaces 400, 410, and 420 which may be provided to users having different roles. In particular, each of the user interfaces may be used to display the same top-level navigable item (and sub-items) in different ways and with different behaviors to users with different roles. More specifically, the user interface 400 of FIG. 4A is displayed to a user have a role of “Corporate,” the user interface 410 of FIG. 4B is displayed to a user having a role of “User,” and the user interface 420 of FIG. 4C is displayed to a user having a role of “Sales Representative.”

As illustrated in FIG. 4A, the user interface 410 displayed to the Corporate user has three sections:
A first section which displays aggregated values based on the applications tied to tiers on which the Corporate user has the “Can View All Applications” claim (permission);
A second section which displays more detailed aggregated values, based on the applications tied to tiers on which the Corporate user has the “Can View All Applications” claim. These values may be recomputed based on filters that are populated with subsets of data within those applications.
A third section which displays a list of the applications tied to tiers on which the Corporate user has the “Can View All Applications” claim.

As illustrated in FIG. 4B, the user interface 410 displayed to the User user has three sections:
A first section which displays a list of products that are linked to an Application Flow navigable item. This section is displayed to the user because the user has the “Can Submit Applications” claim but not the “Can Submit Applications on Behalf of Others” claim.
A second section which displays a list of applications. Because the User user has the “Can View Own Applications” claim but not the “Can View All Applications” claim, this list is restricted to applications in which the User user is an applicant, unlike the list displayed to the Corporate user in FIG. 4A, which lists all applications, including applications in which the Corporate user is not an applicant.
A third section which displays promotional offers.

As illustrated in FIG. 4C, the user interface 420 displayed to the Sales Representative user has three sections:
A first section which displays a list of products with forms that allow for quick entry and which, when completed, take the user to an Application Flow navigable item. This section is displayed to the user because the user has the “Can Submit Applications on Behalf of Others” claim but not the “Can Submit Applications” claim.
A second section which displays a list of applications. Because the Sales Representative User has the “Can View Own Applications” claim but not the “Can View All Applications” claim, this list is restricted to applications in which the Sales Representative user is the sales representative.
A third section which displays aggregated values based on the applications that are tied to tiers in which the Sales Representative user has the “Can View Own Applications” claim and in which the Sales Representative user is the sales representative.

The examples of FIGS. 4A-4C illustrate various ways in which embodiments of the present invention may vary how a navigable item is rendered, which navigable items are rendered, which sub-items of a navigable item are rendered, and how the behavior of navigable items and sub-items may be modified based on the role and tier of the current user.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method performed by at least one computer processor executing computer program instructions stored on at least one non-transitory computer-readable medium, the method comprising:
(A) receiving a first request from a first user to access a portal for processing a financing application;
(B) identifying a first role associated with the first user;
(C) identifying an organization and tier associated with the portal;
(D) granting, to the first user, a first set of privileges to access the tier of the portal as dictated by the first role associated with the first user;
(E) receiving a second request from a second user to access the portal for processing the financing application;
(F) identifying a second role associated with the second user; and
(G) granting, to the second user, a second set of privileges to access the tier of the portal as dictated by the second role associated with the second user;
wherein the first set of privileges differs from the second set of privileges.

2. The method of claim 1:
wherein (D) comprises:
(D) (1) determining, based on the first role associated with the first user, that the first user has permission to view a particular user interface element within the portal;
(D) (2) displaying the particular user interface element to the first user in response to the determination in (D) (1); and
wherein (G) comprises:
(G) (1) determining, based on the second role associated with the second user, that the second user does not have permission to view the particular user interface element within the portal; and
(G) (2) hiding the particular user interface element from the second user in response to the determination in (G) (1).

3. The method of claim 1:
wherein (D) comprises:
(D) (1) modifying, based on the first role associated with the first user, a particular user interface element within the portal to produce a modified user interface element; and
(D) (2) displaying the modified user interface element to the first user.

4. The method of claim 1:
wherein (D) comprises:
(D) (1) modifying, based on the first role associated with the first user, a sequence of user interface elements within the portal to produce a modified sequence of the user interface elements; and
(D) (2) displaying the user interface elements to the first user in the modified sequence.

5. The method of claim 1:
wherein (A) comprises identifying a property of the first request; and
wherein (D) comprises:
(D) (1) selecting a user interface element in the portal based on the identified property of the first request; and
(D) (2) displaying the selected user interface element to the first user.

6. The method of claim 5, wherein the first request comprises an HTTP request.

7. The method of claim 6, wherein the HTTP request comprises a host portion, and wherein the identified property of the first request comprises the host portion of the HTTP request.

8. The method of claim 1, wherein (D) comprises:
(D) (1) accessing data representing a definition of the portal;
(D) (2) identifying a subset of the data representing the definition of the portal; and
(D) (3) granting, to the first user, the first set of privileges to access the identified subset of the data representing the definition of the portal.

9. The method of claim 8, wherein the identified subset of the data represents a single web page.

10. The method of claim 8, wherein the identified subset of the data represents a collection of related web pages.

11. The method of claim 8, wherein the identified subset of the data represents an application for a financing product.

12. The method of claim 8:
wherein (A) comprises receiving the first request from a first computing device of the first user; and
wherein (D) (3) comprises serving the identified subset of the data to the first computing device of the first user.

13. The method of claim 1, wherein the portal is associated with a hierarchy of tiers, and wherein the hierarchy of tiers includes the tier of the portal.

14. The method of claim 13, wherein the first role associated with the first user also is associated with the tier of the portal.

15. The method of claim 13, wherein (D) comprises granting, to the first user, a first set of privileges to access the tier of the portal, and ancestors of the tier in the hierarchy of tiers, as dictated by the first role associated with the first user.

16. A system comprising at least one non-transitory computer-readable medium containing computer program instructions executable by at least one computer processor to perform a method, the method comprising:
(A) receiving a first request from a first user to access a portal for processing a financing application;
(B) identifying a first role associated with the first user;
(C) identifying an organization and tier associated with the portal;
(D) granting, to the first user, a first set of privileges to access the tier of the portal as dictated by the first role associated with the first user;
(E) receiving a second request from a second user to access the portal for processing the financing application;
(F) identifying a second role associated with the second user; and
(G) granting, to the second user, a second set of privileges to access the tier of the portal as dictated by the second role associated with the second user;
wherein the first set of privileges differs from the second set of privileges.

17. The system of claim 16:
wherein (D) comprises:
(D) (1) determining, based on the first role associated with the first user, that the first user has permission to view a particular user interface element within the portal;
(D) (2) displaying the particular user interface element to the first user in response to the determination in (D) (1); and
wherein (G) comprises:
(G) (1) determining, based on the second role associated with the second user, that the second user does not have permission to view the particular user interface element within the portal; and
(G) (2) hiding the particular user interface element from the second user in response to the determination in (G) (1).

18. The system of claim 16:
wherein (D) comprises:
(D) (1) modifying, based on the first role associated with the first user, a particular user interface element within the portal to produce a modified user interface element; and
(D) (2) displaying the modified user interface element to the first user.

19. The system of claim 16:
wherein (D) comprises:
(D) (1) modifying, based on the first role associated with the first user, a sequence of user interface elements within the portal to produce a modified sequence of the user interface elements; and
(D) (2) displaying the user interface elements to the first user in the modified sequence.

20. The system of claim 16:
wherein (A) comprises identifying a property of the first request; and
wherein (D) comprises:
(D) (1) selecting a user interface element in the portal based on the identified property of the first request; and
(D) (2) displaying the selected user interface element to the first user.

21. The system of claim 20, wherein the first request comprises an HTTP request.

22. The system of claim 21, wherein the HTTP request comprises a host portion, and wherein the identified property of the first request comprises the host portion of the HTTP request.

23. The system of claim 16, wherein (D) comprises:
(D) (1) accessing data representing a definition of the portal;
(D) (2) identifying a subset of the data representing the definition of the portal; and
(D) (3) granting, to the first user, the first set of privileges to access the identified subset of the data representing the definition of the portal.

24. The system of claim 23, wherein the identified subset of the data represents a single web page.

25. The system of claim 23, wherein the identified subset of the data represents a collection of related web pages.

26. The system of claim 23, wherein the identified subset of the data represents an application for a financing product.

27. The system of claim 23:
wherein (A) comprises receiving the first request from a first computing device of the first user; and
wherein (D) (3) comprises serving the identified subset of the data to the first computing device of the first user.

28. The system of claim 16, wherein the portal is associated with a hierarchy of tiers, and wherein the hierarchy of tiers includes the tier of the portal.

29. The system of claim 28, wherein the first role associated with the first user also is associated with the tier of the portal.

30. The system of claim 28, wherein (D) comprises granting, to the first user, a first set of privileges to access the tier of the portal, and ancestors of the tier in the hierarchy of tiers, as dictated by the first role associated with the first user.
